(19) United States
(12) Patent Application Publication
(10) Pub. No.: US 2008/0086392 A1
(43) Pub. Date: Apr. 10, 2008

(54) MANAGING DISTRIBUTION OF CONSTRAINED PRODUCT INVENTORY FROM A WAREHOUSE

(76) Inventors: Blair Bishop, Toronto (CA); Neil Park, Nobleton (CA); Janine Serell, New York, NY (US); Ejaz Haider, Markham (CA); Bryan Feng, Mississauga (CA); Shireengul Islam, Mississauga (CA)

Correspondence Address: JAMES M. STOVER;TERADATA CORPORATION, 2835 MIAMI VILLAGE DRIVE, MIAMISBURG, OH, 45342, US

(21) Appl. No.: 11/869,876

(22) Filed: Oct. 10, 2007

Related U.S. Application Data
(60) Provisional application No. 60/828,875, filed on Oct. 10, 2006.

(51) Int. Cl. G06Q 10/00

(52) U.S. Cl. 705/28

(57) ABSTRACT

A method for optimally distributing inventory in short supply from a warehouse to retail stores served by the warehouse. The method compares future store product requirements with future warehouse inventory levels to identify potential product inventory constraints. Once a constrained product is identified, the method automatically adjusts store orders based on store “must have” requirements, prioritization rules selected and ranked by the user, and historical store sales performance.

### FIELD OF THE INVENTION

The present invention relates to the distribution of products from a distribution center or warehouse to retail stores served by the distribution center or warehouse, and more particularly, to methods for optimally distributing inventory in short supply from warehouses to retail stores.

### BACKGROUND OF THE INVENTION

Today's competitive business environment demands that retailers be more efficient in managing their inventory levels to reduce costs and yet fulfill demand. One of the key business objectives retailers are striving to meet is customer satisfaction by having the right merchandise in the right locations at the right time. To that effect it is important that product deliveries become more efficient and store product shortages are minimized. The inability of retailers to efficiently distribute goods through the distribution facilities to the stores has been a major impediment to both maximizing productivity throughout the demand chain and effectively responding to the needs of the consumer.

Teradata, a division of NCR Corporation, has developed a suite of analytical applications for the retail business, referred to as Teradata Demand Chain Management, which provides retailers with the tools they need for product demand forecasting, planning and replenishment. As illustrated in FIG. 1, the Teradata Demand Chain Management analytical application suite 101 is shown to be part of a data warehouse solution for the retail industries built upon NCR Corporation's Teradata Data Warehouse 103, using a Teradata Retail Logical Data Model (RLDM) 105. The key modules contained within the Teradata Demand Chain Management application suite 103, organized into forecasting and planning applications 107 and replenishment applications 109, are:

Demand Forecasting: The Demand Forecasting module 111 provides store/product level forecasting that responds to unique local customer demand. It continually compares historical and current demand and utilizes several methods to determine the best product demand forecast.

Seasonal Profile: The Seasonal Profile module 113 automatically calculates seasonal selling patterns at all levels of merchandise and location, using detailed historical sales data.

Contribution: Contribution module 117 provides an automatic categorization of products, merchandise categories and locations by contribution codes. These codes are used by the replenishment system to ensure the service levels, replenishment rules and space allocation are constantly favoring those items preferred by the customer.

Promotions Management: The Promotions Management module 119 automatically calculates the precise additional stock needed to meet demand resulting from promotional activity.

Automated Replenishment: Automated Replenishment module 121 provides suggested order quantities (SOQs) based on business policies, service levels, forecast error, risk stock, review times, and lead times.

Allocation: The Allocation module 123 determines distribution of products from the warehouse to the store.

As described above, the DCM Replenishment and Allocation modules, 121 and 123, respectively, provide retail store to warehouse suggested order quantities and determine the distribution of products from the warehouse to the retail stores. However, a situation may occur where during a replenishment time period, a distribution center or warehouse has insufficient inventory to satisfy retail store requirements for one or more products, with no prospect of acquiring more inventory in time to resolve the shortfall.

An improved technique for efficiently and equitably distributing constrained product inventory to stores so that the sum of store orders matches the warehouse inventory levels, and store out-of-stock situations are minimized is desired.

### BRIEF DESCRIPTION OF THE DRAWINGS

FIG. 1 provides an illustration of a forecasting, planning and replenishment software application suite for the retail industries built upon NCR Corporation's Teradata Data Warehouse.

FIG. 2 provides a high level flow diagram of the DCM Replenishment process, including a feature for adjusting retail store replenishment for constrained product inventory in accordance with the present invention.

FIG. 3 provides a flow diagram of a process for detecting whether product inventory is constrained in a distribution center or warehouse based upon the product demand of the stores served by the distribution center in accordance with the present invention.

FIGS. 4A and 4B provide a flow diagram of a method for adjusting retail store replenishment for constrained product inventory in accordance with the present invention.

FIGS. 5A through 5C provide a flow diagram of a product order break down process included within the constrained product inventory process illustrated in FIGS. 4A and 4B.

FIG. 6 provides a flow diagram of a tie breaker process for resolving conflicts that may occur during execution of the constrained product inventory process illustrated in FIGS. 4A and 4B.

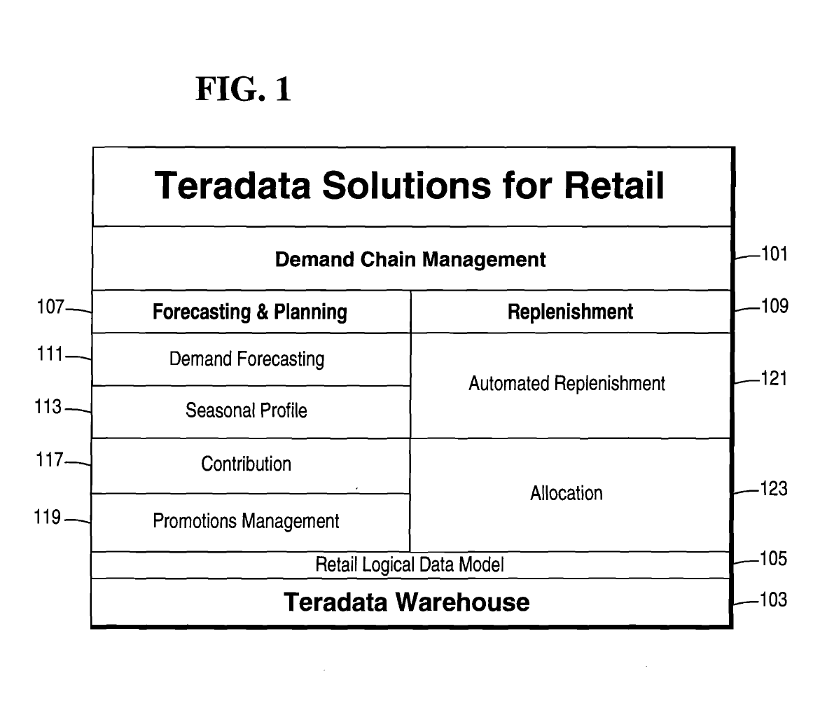

### DETAILED DESCRIPTION OF THE INVENTION

The DCM replenishment process described herein is an automated process that takes place to account for ordering and scheduling data which is related to a particular good, service, or logical and configurable grouping of goods or services. The replenishment service consumes, as input, forecast demand projections, ordering and scheduling data, dependencies, policies, and/or procedures associated with a good and/or service. The replenishment service produces, as output, ordering and scheduling projections and/or instructions, in response to processing its input data.

Some example ordering and scheduling data which may be consumed by a replenishment service as input data includes, but is not limited to, lead time associated with physically acquiring a good after it is ordered, elapsed time before an ordered good arrives in inventory, types of ordering available, vendors available for ordering, risk probabilities associated with choosing a particular type or ordering or particular vendor, parameters for maintaining minimal or optimal inventory levels for a product, and the like. Policies or dependencies may be established for the ordering and scheduling data and expressed as relationships and/or conditions associated with that data.

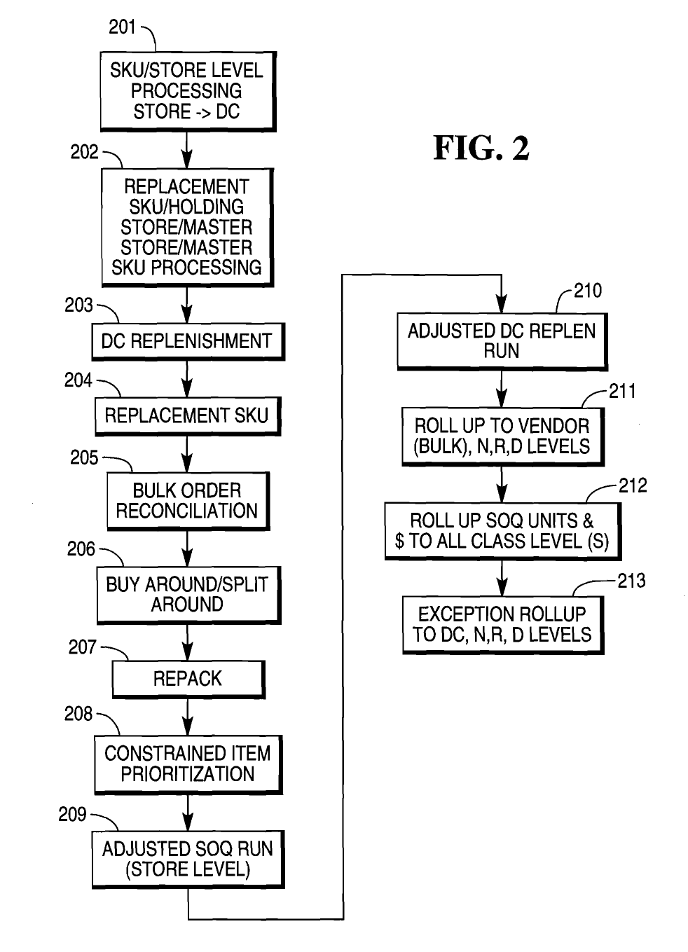

The DCM Replenishment Module 121 employs a batch process to calculate Suggested Order Quantities (SOQs) on a daily basis. Referring now to FIG. 2, a high level flow diagram of the DCM Replenishment process, including a feature for adjusting retail store replenishment for constrained product inventory, is shown.

The primary purpose of the first step, step 201, is to calculate the original Suggested Order Quantities (SOQs) at the Store/Product or SKU (Stock Keeping Unit) level. The system will perform this calculation by reviewing winning policies for each time period along with case pack rounding calculations based on ship level indicators. At step 202, the application calculates SOQs based on store level holding store and replacement SKU assignments. In this phase of the process the application will review the demand and effective inventory of both old and the new SKU to calculate new SOQs.

The application will then roll the sales forecast for any SKU and location where Master Store and Master SKU have been assigned, and calculate SOQs for Dependant Stores and SKU's.

At step 203, the SOQ demand at the store level is summed to the Distribution Center (DC) level as a sales forecast. Based on this forecast and DC Effective Inventory, SOQs are calculated. At step 204, the application calculates SOQs based on Replacement SKU assignments at the DC level.

Step 205 creates Planned and Firm Receipt Records for the near and long term periods. Firm receipts are created for all items, regardless of replenishment status, in order to perform capacity planning functions.

At step 206, the process distributes inventory of old SKUs as defined in a Store's Replacement SKU relationship. The application then reviews the DC available inventory to determine whether there is inventory available on the old SKU, using all of this to fill demand until DC inventory is depleted. Once the inventory at the DC is exhausted, all demand will be replenished with the new SKU.

Repack, step 207, adjusts store level SOQs that are shipped at an inner pack level to total to complete multiples of master packs.

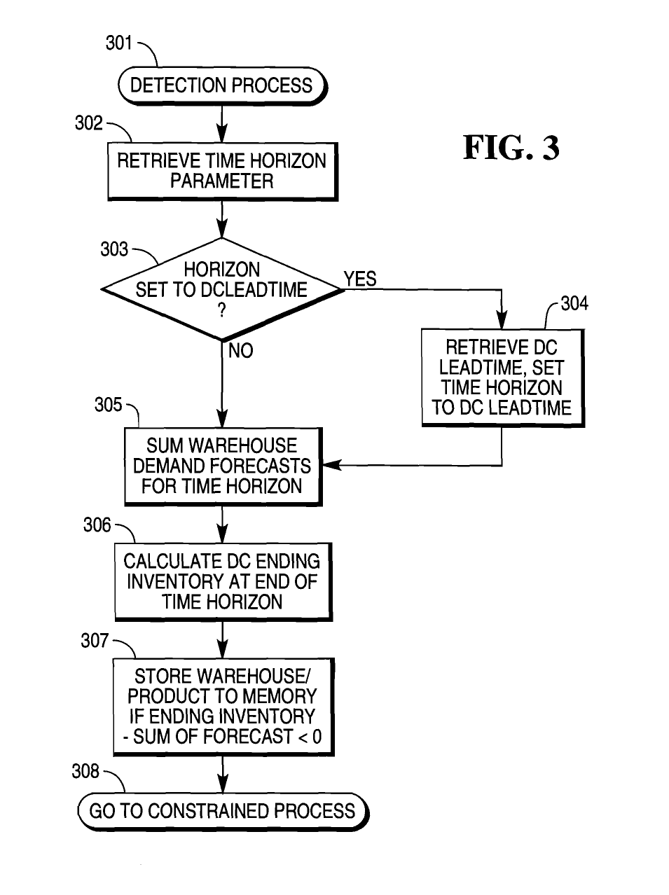

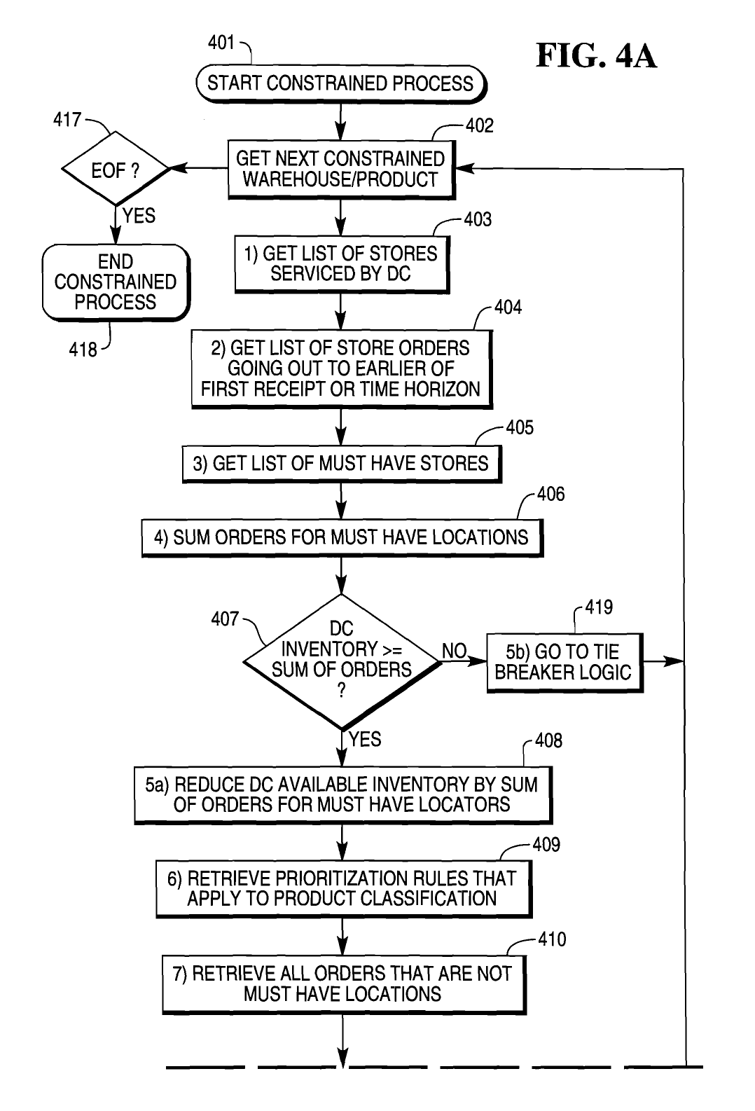

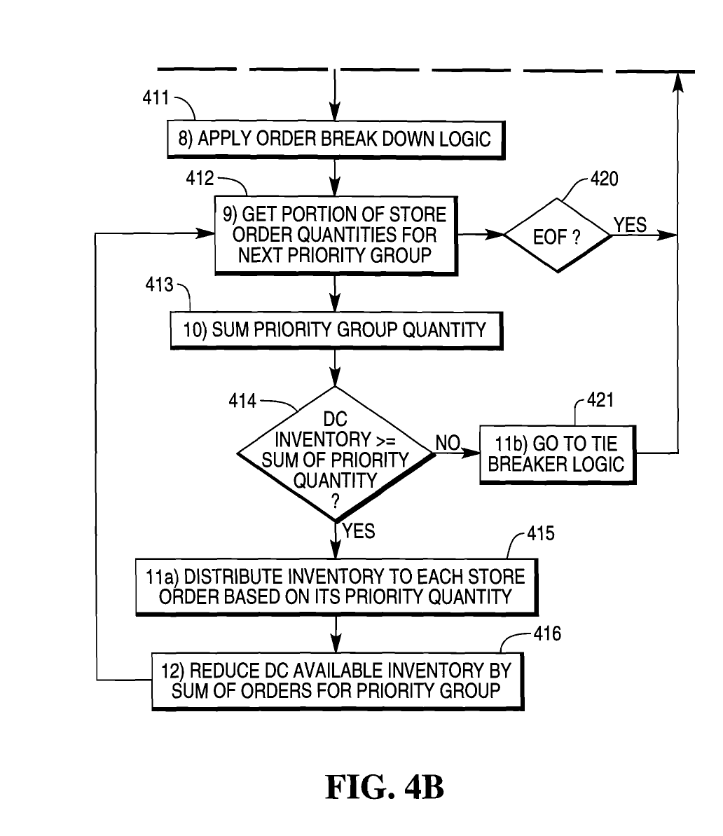

The Constrained Item Prioritization function, shown at step 208, has a detection process to identify any product or SKU where the SOQ summed demand at a store level is greater than the warehouse available inventory. If this is found true, then the prioritization process is executed. The Constrained Item Prioritization Detection process is described below with reference to FIG. 3. The overall Constrained Item Prioritization function is described below and illustrated in FIGS. 4A and 4B.

At steps 209 and 210 SOQs and DC replenishment quantities are adjusted as a result of the Repack (step207), Constrained Item (step 208) and Buy Around (step 206) processes.

At step 211, the SOQs for all SKUs and locations are rolled up to the vendor level, if applicable. SOQs in units are rolled up to bulk, national, regional, and district levels for reporting purposes within the application. SOQs in units and dollars are rolled up to classification IDs for reporting purposes in step 212. Exceptions are identified and rolled up to the DC and the location hierarchy for reporting purposes in step 213.

### Constrained Product Prioritization Process

Constrained products (SKUs) are those products where the aggregated store demand is greater than the inventory available at the DC. The Prioritization Process described herein is initiated when there is constrained product at a single DC. This indicates that there is not enough inventory in that DC to meet the demand from the stores served by the DC before the next order is received. This situation can occur at any time during a replenishment time period, when a warehouse has insufficient inventory to satisfy store requirements, with no prospect of acquiring more inventory in time to resolve the shortfall. This situation calls for a means to reduce shipments to stores so that the sum of the orders matches the warehouse inventory levels.

The Constrained Product Prioritization Process module is designed to optimally distribute inventory in short supply from a warehouse to stores served by the warehouse using a rule based system. This module exploits the Teradata Demand Chain Management Replenishment application, which contains data about future warehouse inventory levels and future store requirements. The module automates a process that would be extremely onerous if carried out manually. If this task was manually carried out, the following would be entailed:

Calculating store requirements for the period of the constraint. In a large enterprise, this task would have to take in the requirements of hundreds of stores with thousands of products over a daily period of 28 days.

Comparing the requirements to the ability of the warehouse to provide the goods. In a large enterprise, this task would have to take in thousands of products for each warehouse.

Once a constrained product was found, each order would have to be broken down according to the prioritization rules.

The store shipments would have to be manually adjusted. In a large enterprise this task would take in the adjustment of hundreds of stores over an extended period of time.

The volume of this work risks inaccuracies.

By leveraging the Teradata Demand Chain Management database and by applying this module, the automation of the above task greatly reduces the manual effort and reduces the possibility of errors. Additionally, the Constrained Product Prioritization module solves the following problems:
A constrained situation may not be handled at all. When the warehouse runs out of stock it is too late to put in a resolution action and the stores serviced by the warehouse will run out of stock.
Inventory distribution is not distributed to optimize its productivity, in that slow selling locations would receive too much inventory and high volume locations would receive too little.
In a situation where a warehouse has a contractual obligation to supply third party retailers, these “must have” locations could be at risk of not being prioritized correctly.
Resource costs are very high to manually priorize constrained products. At best, only a few key products could be managed.

The Constrained Product Prioritization Process module includes four basic components:

A parameter configuration portion that is occasionally updated by the user;

A component to detect constrained prioritization;

A component to apply prioritization rules to reduce store orders; and

An online review process to allow the user to override the adjustments as required.

### Parameter Configuration

There are two sets of parameters to configure: the time horizon to evaluate constrained products, and prioritization rule ranking. The time horizon parameter is updated by the user. In the embodiment described, this value can range from 7 to 28 days, or the special indicator “99”. If the user has entered a value between 7 and 28 days, this indicates to the system the number of days of forecast to search for constrained products. If the User has entered the special indicator, the system will use the warehouse's leadtime to search for constrained orders.

The embodiment described herein includes five prioritization rules that a user can select and rank:

| Prioritization | |
|---|---|
| Category | Description |
| Must Have | Select a Location Attribute containing Stores which have |
| Locations | previously been set up in Location Attribute |
| | Maintenance. Only 1 Location Attribute may be selected. |
| Inventory | The inventory needed by the store to reach the minimum |
| Demand - | quantity set in the Replenishment Strategy Policy. |
| Minimum | |
| Quantity | |
| Total Sales | The quantity needed by the store to meet their forecasted |
| Forecast | sales demand. |
| Safety Stock | The quantity needed to meet the safety stock policy set |
| | for the store. The safety stock is calculated based on the |
| | Service Level % set in the Service Level policy and the |
| | AFE. |
| Planned Sales | The quantity needed to meet the PSD policy set for the |
| Days (PSD) | store. |
| Balance of the | The remaining balance of the SOQ not fulfilled by any of |
| SOQ | the selected prioritization categories. |

Except for Must Have Locations, these rules pertain to portions of a store order. Each store or warehouse order quantity is based on forecast sales, minimum shelf display, safety stock and planned sales days. By selecting and ranking the rules, the system will adjust store orders in a way that reflects business policy. For example an enterprise may want display minimum quantities satisfied before safety stock quantities which may have a higher ranking than planned sales days.

### Constrained Inventory Detection Process

This first step in the Constrained Product Prioritization Process is to identify whether a product is constrained in the warehouse. This is based on the demand of the stores that are serviced by that warehouse. A product is identified as constrained, also referred to herein as CIDP, when the warehouse Ending On Hand for the product is less than the sum of the Sales Forecast for a defined time horizon.

The Constrained Inventory Detection Process module mines warehouse replenishment data stored in the Teradata Demand Chain Management database as follows:

The Sales Forecast will be summed for the earlier of the next x days (set via a system switch up to 28 days or warehouse lead time) or the day of the next receipt.

Ending On Hand=Beginning on Hand—Summed Sales Forecast at a point that is the earlier of a receipt or end of horizon.

If the Ending On Hand value is less than zero, the product is identified as a constrained product.

The Constrained Inventory Detection Process is illustrated in the flow diagram of FIG. 3. At step 302, the process retrieves the time horizon parameter set by the user. At step 303, the process checks to determine if the user has entered a parameter indicating the warehouse leadtime is to be used for constrained inventory detection. If selected, the process sets the time horizon to the warehouse leadtime, as shown in step 304.

Warehouse demand forecasts for a product for the selected period, or warehouse leadtime, are summed in step 305, and warehouse ending inventory for the product is calculated in step 306. At step 307, if the ending product inventory from step 306, less the sum of the demand forecasts from step 305, is less than zero, the product is determined to be constrained.

### Constrained Product Order Prioritization

The prioritization process begins when a CIDP exists at a warehouse level, i.e., when there is a shortage of available product on hand as compared to demand. The prioritization process allocates a portion of the warehouse on hand inventory to the store SOQs. This process allows the organization to set their priorities for stores to receive goods where the demand exceeds the supply. After the process allocates based on the first prioritization category chosen it subsequently allocates for each remaining category based on the ranking, until all inventory has been allocated to the Stores.

The Constrained Product Order Prioritization process is illustrated in the flow diagram of FIGS. 4A and 4B, the major steps of which are discussed below. As indicated in step 402, the prioritization process is repeated for each product which has been identified as constrained.

At steps 403-404, the system retrieves all orders for all stores serviced by the warehouse for the prioritization window. The prioritization windows refers to all orders from the current daily run date out to the next Receipt date or the parameter that defines the time horizon, whichever is less. Thus, although the warehouse may be able to fulfill all next day orders, because a constraint occurs farther out in the future, all orders out to the defined time horizon will be subject to being reduced.

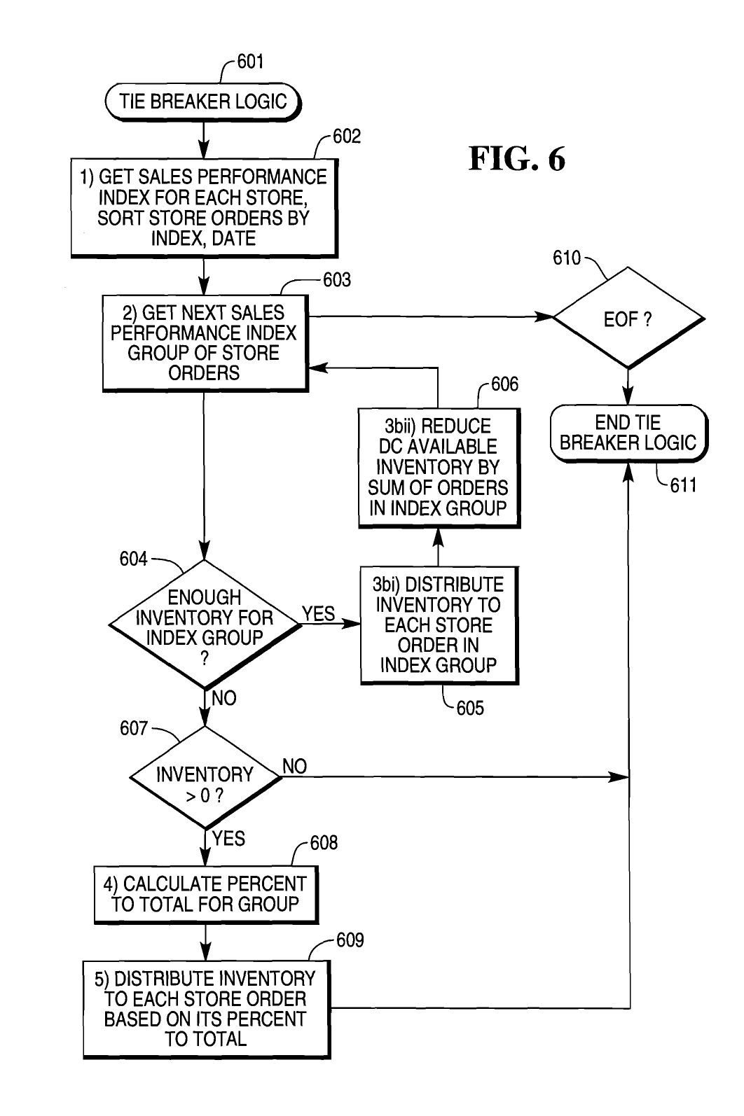

At step 405-407, the system retrieves a list of Must Have stores serviced by the warehouse and designated as Must Have in the Constrained Item Prioritization Rules table. The prioritization module will attempt to fulfill these orders in their entirety, employing tie breaker logic (step 419) if the warehouse has insufficient inventory to service all the must have locations. The tie-breaker process is illustrated in the flow diagram of FIG. 6, discussed in greater detail below.

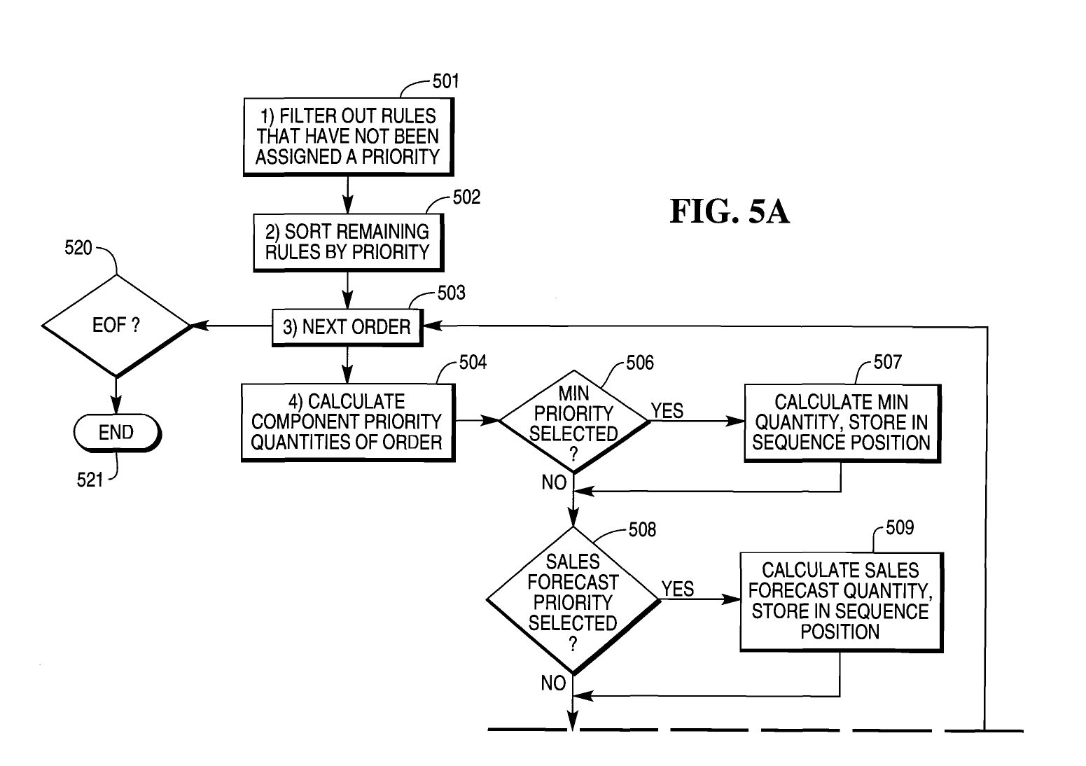

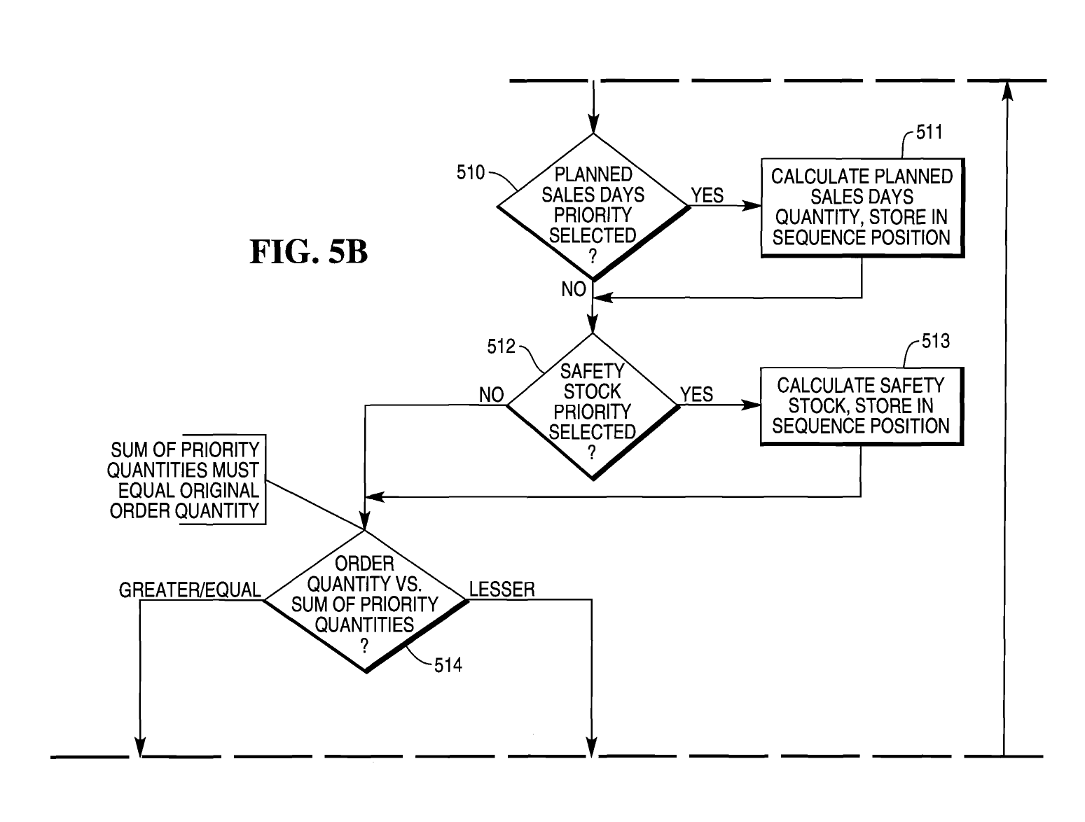

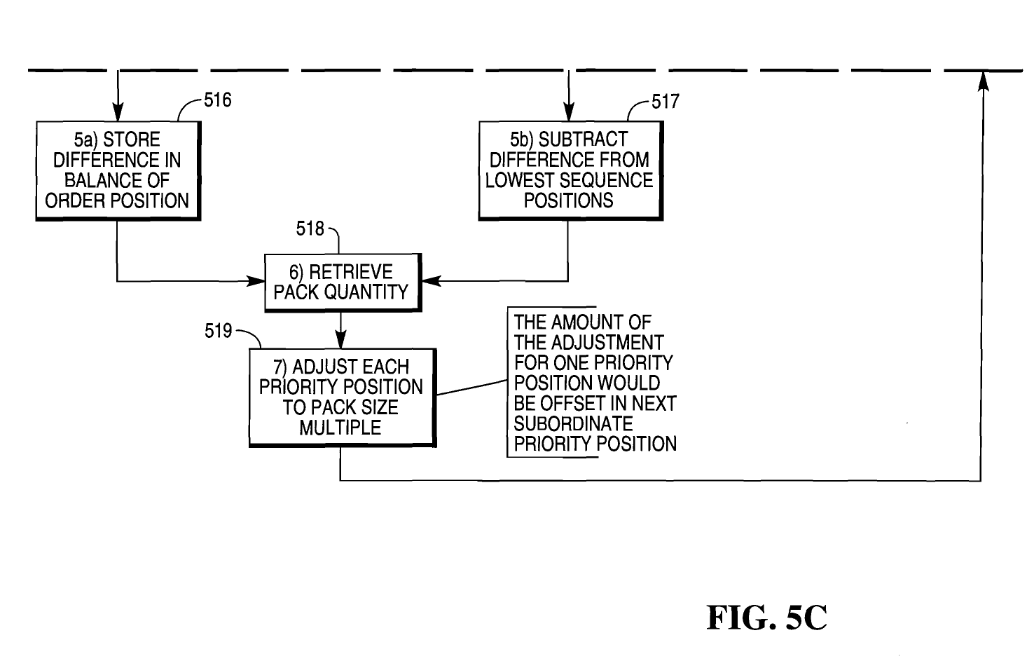

At step 408 the remaining balance of the warehouse inventory is determined by reducing the beginning inventory balance by the portion of the inventory allocated to the Must Have Locations. The balance will then be distributed to those orders that are not part of the Must Have Locations in accordance with the Prioritization Rule as selected and ranked by the user. At steps 409-411, and corresponding with the Priority Rules described earlier, each order will have its quantity broken out into the following components: sales forecast, minimum shelf display, safety stock, planned sales days, and balance of the order that exceeds the sum of the above four components. The order break down logic is illustrated in the flow diagram of FIGS. 5A through 5C.

At steps 412-416, following completion of order breakdown, the system will evaluate each breakdown in order of user ranking and order date. For example if Minimum Shelf Display was ranked first, the module will evaluate that quantity for each order in the time horizon. If warehouse inventory levels are sufficient, the module will evaluate each subsequent breakdown in order of priority, until all warehouse inventory is depleted. Any remaining component will not be satisfied, i.e., the orders will be adjusted to match the satisfied components. If the warehouse inventory is such that only part of a rule can be satisfied, the module will apply tie breaking logic (step 421).

Referring now to FIGS. 5A through 5C, a flow diagram of the product order break down process included within the constrained product inventory process is illustrated. The process successively evaluates each store/product order as shown in steps 504 through 519 to calculate minimum store quantity (steps 516-507), sales forecast quantity (steps 508-509), planned sales days quantity (steps 510-512), and safety stock quantity (steps 512-513).

It is possible that the sum of the above components exceeds the order quantity because the order quantity was reduced by current store on hand inventory. In such case, the above components will be reconciled to the original order quantity by reducing the lowest ranked priorities until the sum of the break down matches the original quantity.

The order break down process will also retrieve pack quantity for each store and product (step 518), and adjust each priority quantity to the pack size multiple (step 519).

Pack size dictates that only entire packs are shipped, not broken packs. Because broken packs are not shipped, the warehouse will potentially run out of inventory earlier than if broken packs were shipped and thus may not supply some stores. Pack size adjustments are made at the individual rule level in order ensure entire pack quantities are shipped for each rule. The prioritization process disclosed herein does not perform pack size adjustments for Must Have Locations, as the SOQ has already been rounded for Ship Level prior to performing prioritization.

Once all pack adjustments are made for a rule, the system will verify whether there is sufficient inventory for the rule, by summing the requirements for the rule and comparing the sum to the remaining undistributed inventory on hand.

The tie breaker process, illustrated in FIG. 6 provides a mechanism for resolving conflicts that may occur during execution of the constrained product inventory process. The tie breaker process utilizes a sales performance indicator ranking for each store and product, grouping the stores into five sales performance categories (step 602). Store orders will be ordered by this category indicator. The tie breaker process successively evaluates each performance group as shown in steps 603 through 606, to fill the requirements of stores with higher sales performance. If insufficient inventory remains within a category, the system will sum the remaining SOQs and calculate a percentage for each SOQ (step 608), and distribute the remaining inventory to the stores based upon each store's percentage of total for the group (step 609).

### Conclusion

The Figures and description of the invention provided above reveal a system and method for optimally distributing inventory in short supply from a warehouse to retail stores served by the warehouse. The method compares future store product requirements with future warehouse inventory levels to identify potential product inventory contraints. Once a constrained product is identified, the method automatically adjusts store orders based on store “must have” requirements, prioritization rules selected and ranked by the user, and historical store sales performance. Store shipments are reduced in the most advantageous manner so that the sum of the orders matches the warehouse inventory levels.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for distributing product inventory from a warehouse to a plurality of stores served by the warehouse, the method comprising the steps of:
receiving store orders from said plurality of stores, each store order specifying a quantity of a product desired by a store during a defined time horizon;
summing the product quantities from said store orders;
comparing the sum of said store order product quantities with an inventory value of said product available for distribution from said warehouse to said plurality of stores during said defined time period;
when said inventory value is less than said sum of said store order product quantities for said defined time horizon, automatically reducing the size of said store order product quantities so that the sum of said store order product quantities does not exceed the inventory value of said product for said defined time horizon.

2. The method for distributing product inventory from a warehouse to a plurality of stores in accordance with claim 1, wherein:
said step of automatically reducing the size of said store order product quantities reduces the product quantity associated with each store order in an equivalent proportion.

3. The method for distributing product inventory from a warehouse to a plurality of stores in accordance with claim 2, wherein the size of the reduction in said store order product quantities is proportional to the difference between the sum of said store order product quantities and the inventory value of said product available for distribution from said warehouse to said plurality of stores during said defined time period.

4. The method for distributing product inventory from a warehouse to a plurality of stores in accordance with claim 1, wherein:
said plurality of stores includes a first group of “must have” stores and a second group of stores; and
said step of automatically reducing the size of said store order product quantities comprises automatically reducing the size of said store order product quantities associated with said second group of stores so that the sum of said store order product quantities from said first group of stores and said second group of stores does not exceed the inventory value of said product for said defined time horizon.

5. The method for distributing product inventory from a warehouse to a plurality of stores in accordance with claim 4, wherein:
said first group of stores comprises at least one store.

6. The method for distributing product inventory from a warehouse to a plurality of stores in accordance with claim 1, wherein:
said store orders comprise a plurality of order components, each order component specifying a product quantity and having a component priority value;
said step of automatically reducing the size of said store order product quantities comprises automatically reducing the size of said store order component product quantities in accordance with said component priority values until the sum of said store order product quantities does not exceed the inventory value of said product for said defined time horizon.

7. The method for distributing product inventory from a warehouse to a plurality of stores in accordance with claim 6, wherein said order components comprise:
a forecast sales component;
a minimum shelf display component;
a safety stock component; and
a planned sales days component.

8. The method for distributing product inventory from a warehouse to a plurality of stores in accordance with claim 1, wherein:
said step of automatically reducing the size of said store order product quantities reduces the product quantity associated with each store order in accordance with a sales performance indicator ranking for each store.

9. The method for distributing product inventory from a warehouse to a plurality of stores in accordance with claim 1, wherein:
said product is maintained in inventory in product packs; and
said step of automatically reducing the size of said store order product quantities reduces the product quantity associated with each store order in increments corresponding to the quantity of product contained within said product packs.

10. A computer program, stored on a tangible storage medium, for determining the distribution of product inventory from a warehouse to a plurality of stores served by the warehouse, the program including executable instructions that cause a computer to:
receive store orders from said plurality of stores, each store order specifying a quantity of a product desired by a store during a defined time horizon;
sum the product quantities from said store orders;
compare the sum of said store order product quantities with an inventory value of said product available for distribution from said warehouse to said plurality of stores during said defined time period;
when said inventory value is less than said sum of said store order product quantities for said defined time horizon, automatically reduce the size of said store order product quantities so that the sum of said store order product quantities does not exceed the inventory value of said product for said defined time horizon.

11. The compute program, stored on a tangible storage medium, in accordance with claim 10, wherein:
said plurality of stores includes a first group of “must have” stores and a second group of stores; and
said step of automatically reducing the size of said store order product quantities comprises automatically reducing the size of said store order product quantities associated with said second group of stores so that the sum of said store order product quantities from said first group of stores and said second group of stores does not exceed the inventory value of said product for said defined time horizon.

12. The compute program, stored on a tangible storage medium, in accordance with claim 10, wherein:
said store orders comprise a plurality of order components, each order component specifying a product quantity and having a component priority value;
said step of automatically reducing the size of said store order product quantities comprises automatically reducing the size of said store order component product quantities in accordance with said component priority values until the sum of said store order product quantities does not exceed the inventory value of said product for said defined time horizon.

13. A computer system comprising:
a storage device containing a computer program for determining the distribution of product inventory from a warehouse to a plurality of stores served by the warehouse, the computer program including executable instructions that cause said computer to:
receive store orders from said plurality of stores, each store order specifying a quantity of a product desired by a store during a defined time horizon;
sum the product quantities from said store orders;
compare the sum of said store order product quantities with an inventory value of said product available for distribution from said warehouse to said plurality of stores during said defined time period;
when said inventory value is less than said sum of said store order product quantities for said defined time horizon, automatically reduce the size of said store order product quantities so that the sum of said store order product quantities does not exceed the inventory value of said product for said defined time horizon; and
a processor for executing said computer program.

14. The computer system in accordance with claim 13, wherein:
said plurality of stores includes a first group of “must have” stores and a second group of stores; and
said step of automatically reducing the size of said store order product quantities comprises automatically reducing the size of said store order product quantities associated with said second group of stores so that the sum of said store order product quantities from said first group of stores and said second group of stores does not exceed the inventory value of said product for said defined time horizon.

15. The computer system in accordance with claim 13, wherein:
said store orders comprise a plurality of order components, each order component specifying a product quantity and having a component priority value;
said step of automatically reducing the size of said store order product quantities comprises automatically reducing the size of said store order component product quantities in accordance with said component priority values until the sum of said store order product quantities does not exceed the inventory value of said product for said defined time horizon.
